(19) United States
(12) Patent Application Publication
(10) Pub. No.: US 2004/0255123 A1
(43) Pub. Date: Dec. 16, 2004

(54) Data embedding method and viewing confirmation method

(76) Inventors: Hideo Noyama, Yokohama (JP); Yuichiro Nakagawa, Sagamihara (JP); Takeshi Matsuki, Musashino (JP); Shuji Terada, Kawasaki (JP); Kazumi Yamamoto, Tokyo (JP)

Correspondence Address: MCDERMOTT, WILL & EMERY, 600 13th Street, N.W., Washington, DC, 20005-3096, US

(21) Appl. No.: 10/788,033

(22) Filed: Feb. 27, 2004

(30) Foreign Application Priority Data
Feb. 27, 2003 (JP) 2003-050247

(51) Int. Cl. H04L 9/00; H04N 7/167

(52) U.S. Cl. 713/176; 380/201; 382/250

(57) ABSTRACT

In the prior art, because only several bits in digital watermark data can be allocated to an area where information itself is described, complicated information cannot be described in the area. Additionally, because only a check code of several bits can be used, there is a security problem in embedding an electronic value. A content delivery server 100 comprises means for dividing secret data, means for dividing content data by the same number as the divided secret data, means for embedding the secret data in the content data blocks, and means for generating a content having a digital watermark by integrating the content data blocks. A user terminal 130 includes means for extracting the secret data when the content is played. A verification server 120 includes means for validating the secret data recovered from a user terminal to tally up the number of the validated secret data.

### FIELD OF THE INVENTION

The present invention relates to a device and method for delivering via a network to a user terminal digital contents (including a license for decrypting the digital content) in which secret data is embedded.

### BACKGROUND OF THE INVENTION

As a prior art, JP-A No. 366032/2002 discloses a contents delivery method having the steps of: embedding security information in a content as digital watermark information; delivering to a user via a broadcast or network the content in which the digital watermark information is embedded and recording the content in a nonvolatile storage medium of the user; and managing the content according to the security information, which is the digital watermark information read out from the nonvolatile storage medium. According to this invention, because the digital watermark data is used as high-security encrypted data, and the content is managed such that security information is embedded in content information, the digital watermark data can be efficiently used. Additionally, because service information can be embedded in images of, e.g., a broadcast to provide the service to the user, the digital watermark data can be efficiently used.

In the prior art, the digital watermark data is used as high-security encrypted data difficult to tamper, and by embedding security and service information in content information, the digital watermark data can be used not only as management IDs of contents, but also as other various services.

However, because the digital watermark data of ten and several bits is divided into three portions for type description, management value description, and check code description, only several bits can be allocated to the management value description portion, and thus complicated information cannot be described in the management value description portion. Additionally, when secret data is described in the management value description portion, it is hard to say that security guaranteed by a check code of several bits is high. Therefore, it is impractical that electronic values themselves such as points and electronic money are described as the management value.

### SUMMARY OF THE INVENTION

A first object of the present invention is to provide a device and method for embedding secret data having large capacity (e.g., thousands of bits) in digital contents.

A second object of the present invention is to provide a device and method for easily confirming whether a complete content has been viewed.

The following configuration is to achieve the first object. A content delivery server includes means for dividing secret data, means for providing a header to a divided secret data block to generate partial secret data, means for dividing content data by the number of the divided secret data blocks, and means for embedding the partial data in a divided content data block without overlap.

The following configuration is to achieve the second object. The content delivery server comprises means for solving the first object, and means for integrating the content data blocks in which the secret data are embedded to generate a content having a watermark. A user terminal includes means for storing the contents having the watermarks in a content storage portion and extracting the secret data when the contents are played, and means for storing the secret data in a secure storage portion, access to which is controlled. A verification server comprises means for validating the secret data recovered from the user terminal, and means for counting the number of valid secret data to tally up digital contents which have been viewed.

### BRIEF DESCRIPTION OF THE DRAWINGS

FIG. 1 shows a system structure for achieving the present invention.

FIG. 2 is a flowchart showing an outline of a process for embedding secret data in digital contents such as moving images.

FIG. 3 is a plain explanation view showing a structure of data processed through the flowchart of FIG. 2.

FIG. 4 is a flowchart showing a process that a player/watermark extraction application extracts the secret data from the digital contents such as moving images stored in a content storage portion 132 of a user terminal 130.

FIG. 5 is a flowchart showing a process that a verification server 120 validates the secret data recovered from a secure storage portion 136 of the user terminal 130.

FIG. 6 is an explanation view showing an internal structure of the user terminal 130.

FIG. 7 is a table showing a structure of a content management database 226 of the content delivery server 100.

FIG. 8 is a management table of the verification server 120.

### DESCRIPTION OF THE PREFERRED EMBODIMENT

Embodiments of the present invention are explained in the following.

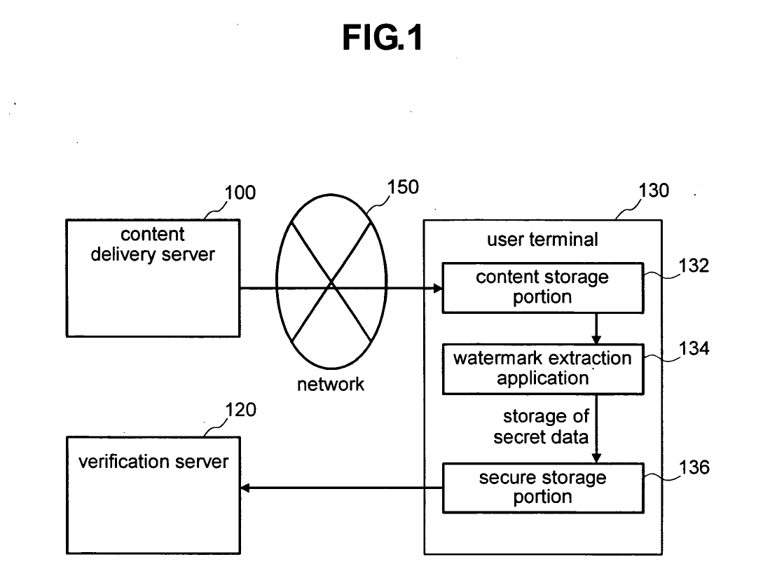

FIG. 1 shows a system structure for achieving the present invention.

Participants of the present invention are a deliverer of moving images (content delivery server 100), a viewer (user terminal 130), and a service provider (verification server 120).

The content delivery server 100, user terminal 130, and verification server 120 are connected to each other via an open network 150. The open network 150 may be a public line or private line, and may be wired or radioed.

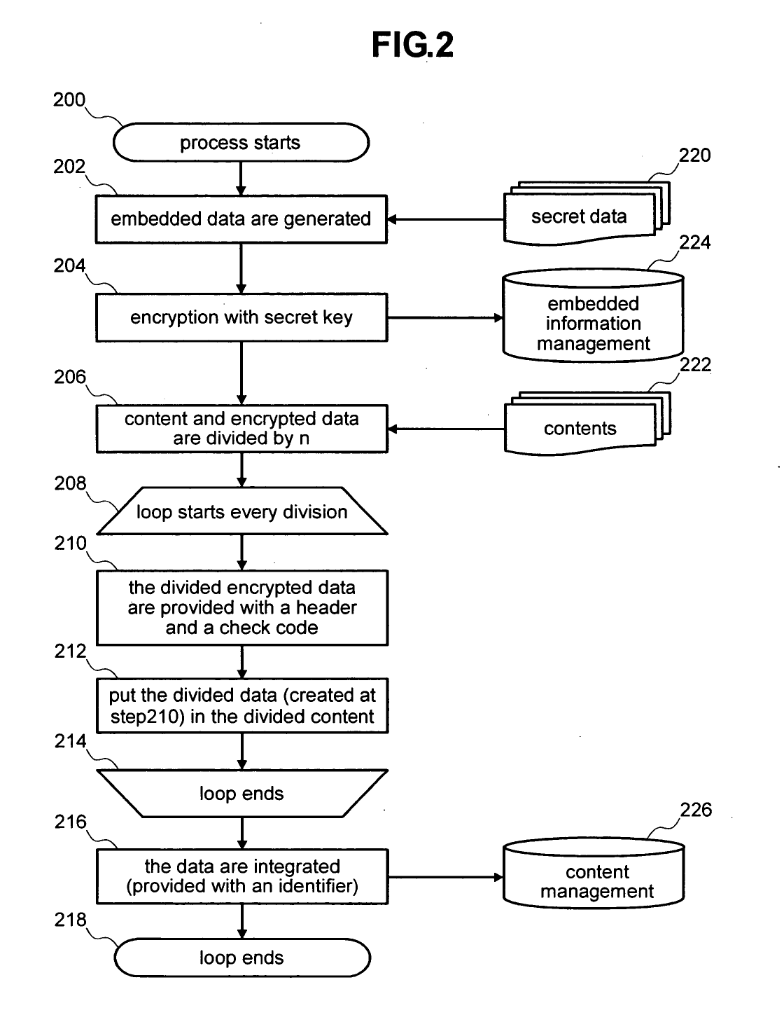

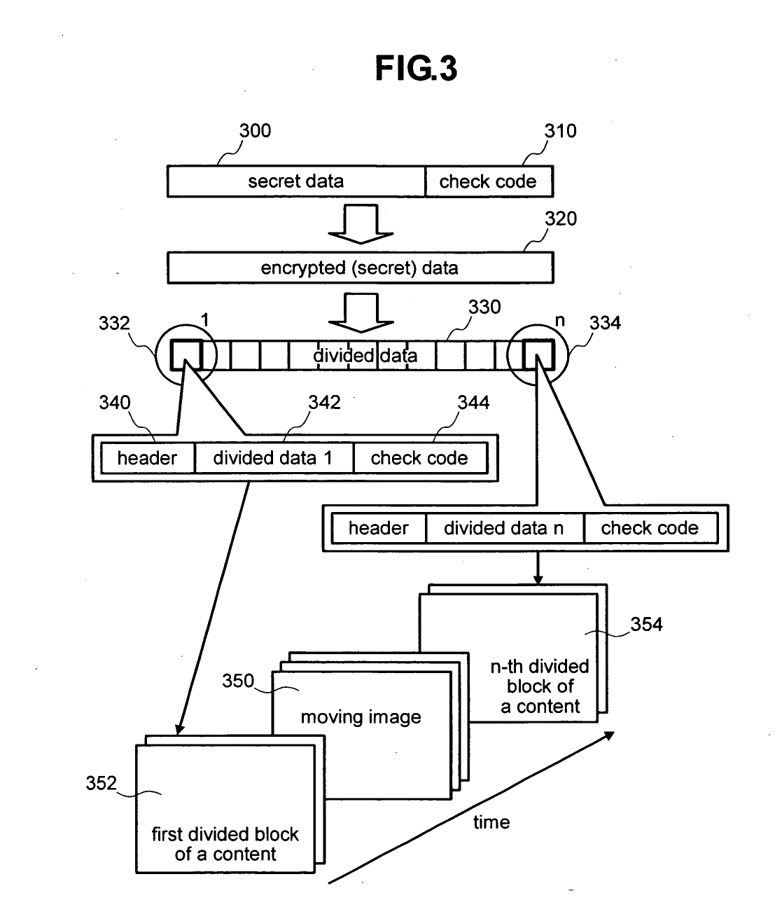

FIG. 2 is a flowchart showing an outline of a process for embedding secret data in digital contents such as moving images. FIG. 3 is a brief explanation view showing data processed through the flowchart of FIG. 2.

First, the process for embedding the secret data in the digital contents such as the moving images is explained.

In step 200, a processing unit of the content delivery server 100 starts the process.

In step 202, the content delivery server 100 receives secret data 220 or reads out it from a database, and then generates embedded data by use of the secret data 220, which needs to be secret. The content delivery server 100 generates a check code 310 for the secret data 220 by operating a one-way function such as a digest function and a hashing function upon a value of the secret data 220 (e.g., a value of an electronic value of the secret data 220), and provides the check code 310 to the secret data 220 to generate the embedded data. Accordingly, it can be detected whether the value of the electronic value is tampered. As shown in FIG. 3, the embedded data is the secret data provided with the check code 310.

In step 204, the content delivery server 100 reads from the database a secret key paired with a public key stored in the user terminal using the contents. This embedded data is electronically signed (encrypted) using the secret key of the content delivery server to generate encrypted data 320 as shown in FIG. 3. In other words, the database of the content delivery server 100 stores the secret key paired with the public key stored in the user terminal 130, which secret key corresponds to an identification code of the user terminal 130 or of its user. The content delivery server 100 receives a content delivery request from the user terminal 130 together with the identification code of the user terminal 130 or of its user. The content delivery server 100 searches the secret key from the database by using the identification code of the user terminal 130 or of its user as a search key, and then stores the embedded data in an embedded information management database 224.

In step 206, the encrypted data 320 is divided by n, which is a value equal to or over two (a first divided data block 332, a last divided data block 334). For example, data encrypted with a key of 1,024 bits becomes at least 1,024 bits. When the data is divided by 100, a divided data block becomes about 10 bits.

The content delivery server 100 reads out a content from a content database, and divides the content by n in which for example, a first divided block 352, a k-th divided block 350 (1<k<n), and an n-th divided block 354 are generated. The number of the divided contents are not limited to n as long as it is equal to or over n. The partial data obtained by the division do not need to be always equal. Next, processes of steps 208 to 214 are repeated every data division.

In step 210, the divided data 342 is provided with an identification number of the secret data and the order (in the divided data blocks) as a header 340. The content delivery server 100 generates a check code 344 for the divided data by operating a one-way function such as a digest function and a hash function for a value of the divided data, and provides the check code 344 to the divided data.

In step 212, the divided data processed in step 210 is embedded in a partial content of the corresponding order as a digital watermark. In other words, the data block 332 is embedded in the first divided block 352 as a watermark, and the data block 334 is embedded in the n-th divided block 354 as a watermark. Methods of digital watermarking for moving images has been described in, e.g., pages 132 to 145 in “Basics of Watermark (Koshio Matsui, Morikita Shuppan Co., Ltd. ISBN 4-627-82551-X)”, where redundancy in the time direction of a moving image and redundancy in the space direction of an image are used. The present invention is not limited to these methods.

In a loop process from step 208 to step 214, when all divided data are processed, the partial contents provided with watermarks are sequentially integrated in step 216. The integrated content is provided with a content identifier. The content identifier is information such as a content title, and used in generating a title list in the user terminal. The user selects one title from this title list to specify a moving image file to be played in the user terminal. This content is stored in the content management database 226, and the process in the content delivery server ends.

FIG. 7 is a table showing a structure of the content management database 226 of the content delivery server 100. This table 700 is comprised of at least a management number 710, an identifier 720 showing a type of content, a content title 730, a file name 740, and a content delivery frequency 750.

A program (not shown) for managing the digital contents and delivering them via the network is also stored in the content delivery server 100. The content delivery server 100 may deliver the integrated content to the user terminal 130 at a time or deliver each partial content by using packets.

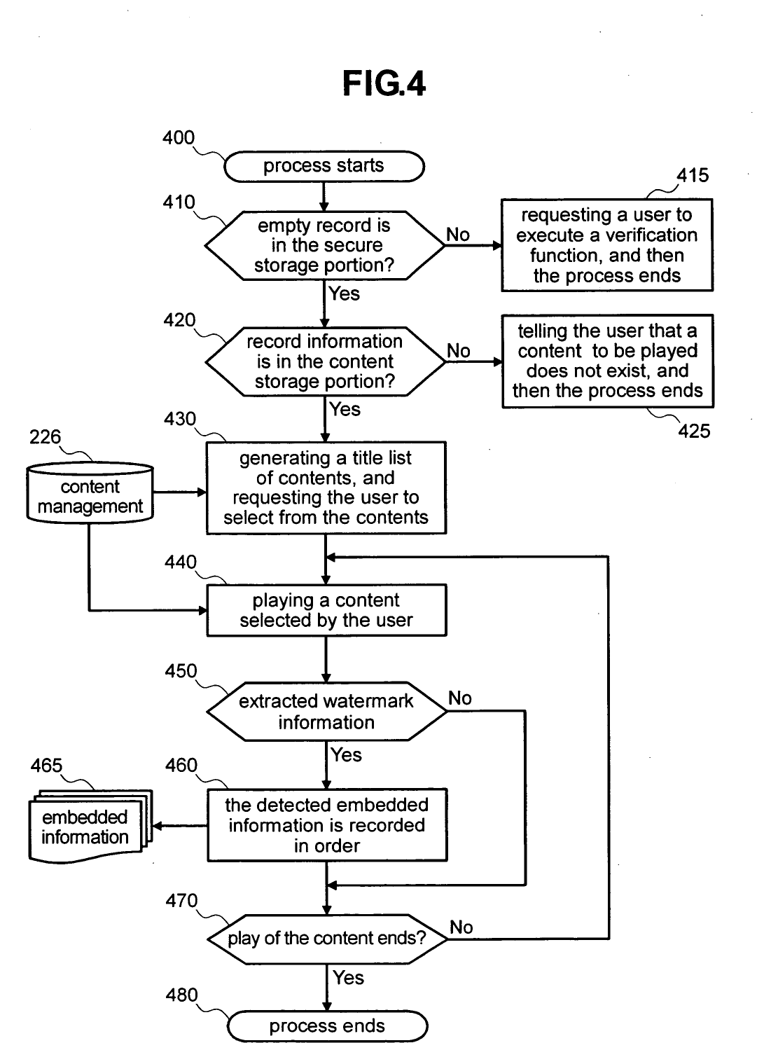

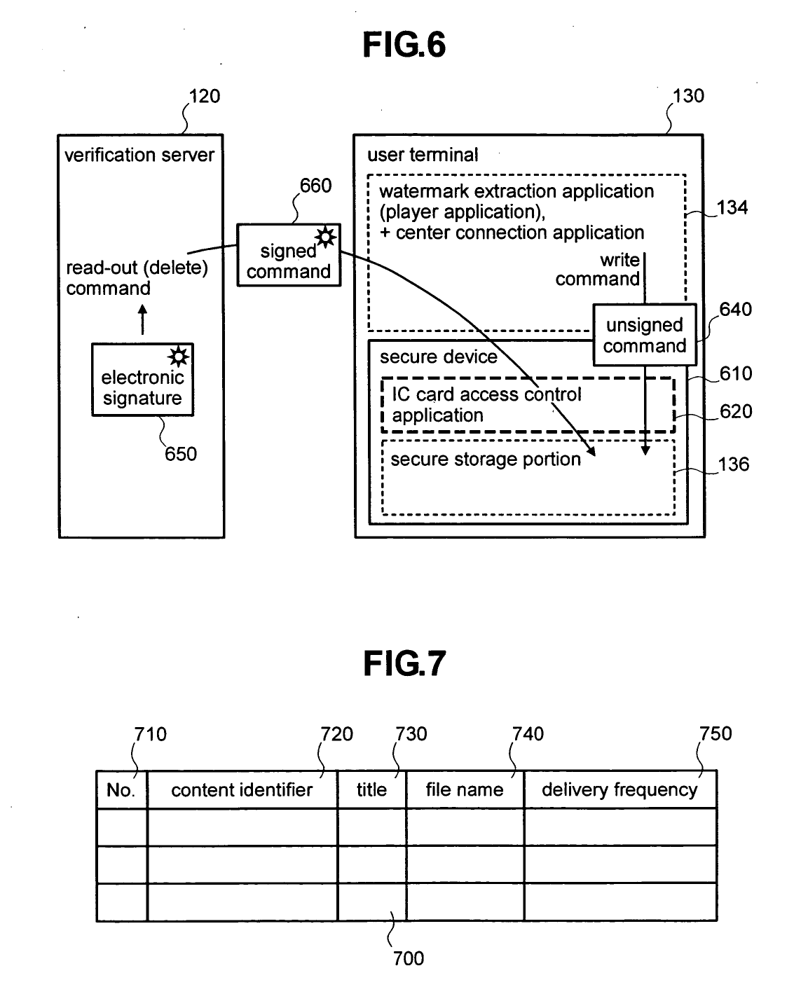

FIG. 4 is a flowchart showing a process that a player/watermark-extraction application (AP) 134 extracts the secret data from the digital contents such as the moving images stored in a content storage portion 132 of the user terminal 130. FIG. 6 is an explanation view showing an internal structure of the user terminal 130. The user terminal includes a normal memory and a secure device. The player application 134 and the content data are stored in the normal memory. On the other hand, an IC card access control application 620 for controlling access to the secure storage portion, and the secret data are recorded in a secure device 610.

In step 400, the player application 134 for extracting the secret data embedded as the digital watermark starts the process. First, in step 410, the player application checks whether there is an empty record in the secure storage portion 136 of the user terminal 130. When there is no empty record in this step, the player application displays a message to upload the data stored in the secure storage portion on a display of the user terminal 130 in step 415, and then this process ends.

When there is an empty record, the player application, in step 420, checks whether a content to be played is in the content storage portion. When in this step there is no record information of the content, the player application, in step 525, displays on the display of the user terminal 130 a message that there is no content to be played, and then this process ends.

When there is a content to be played, the player application, in step 430, produces a title list of the contents stored in the content management database 226, and prompts the user to specify a content to be played. In step 440, the player application plays the content selected by the user.

In step 450, the player application extracts watermark information embedded in the content. When the watermark information is extracted, the player application stores the detected embedded information sequentially in the secure storage portion 136 in step 460. At this time, the IC card access control application 620 checks whether a command is provided with an electronic signature, and permits the command to execute only addition in the secure storage portion when the command is an unsigned command 640 generated by the player application. On the other hand, the verification server 120 generates a command 660 provided with an electronic signature thereof to read the secret data stored in the secure storage portion. The IC card access control application 620 permits only a valid electronically-signed command to execute overwriting and deleting in the secure storage portion. Accordingly, the user can execute addition in the secure storage portion 136 via the player application, but cannot operate the stored data.

When no watermark information is detected, the process for reading the content is interrupted, and then in step 470, it is asked whether the play of the content is ended. When the play is not ended, the process returns to step 440 to prompt an input for selection of another content.

The player application executes the above-described processes, so that the embedded information 465 can be extracted from the content, and one electronically-signed secret data can be extracted by playing one content from beginning to end. When the secret data is extracted, the user terminal 130 (user) is provided with the secret data (e.g., electronic money).

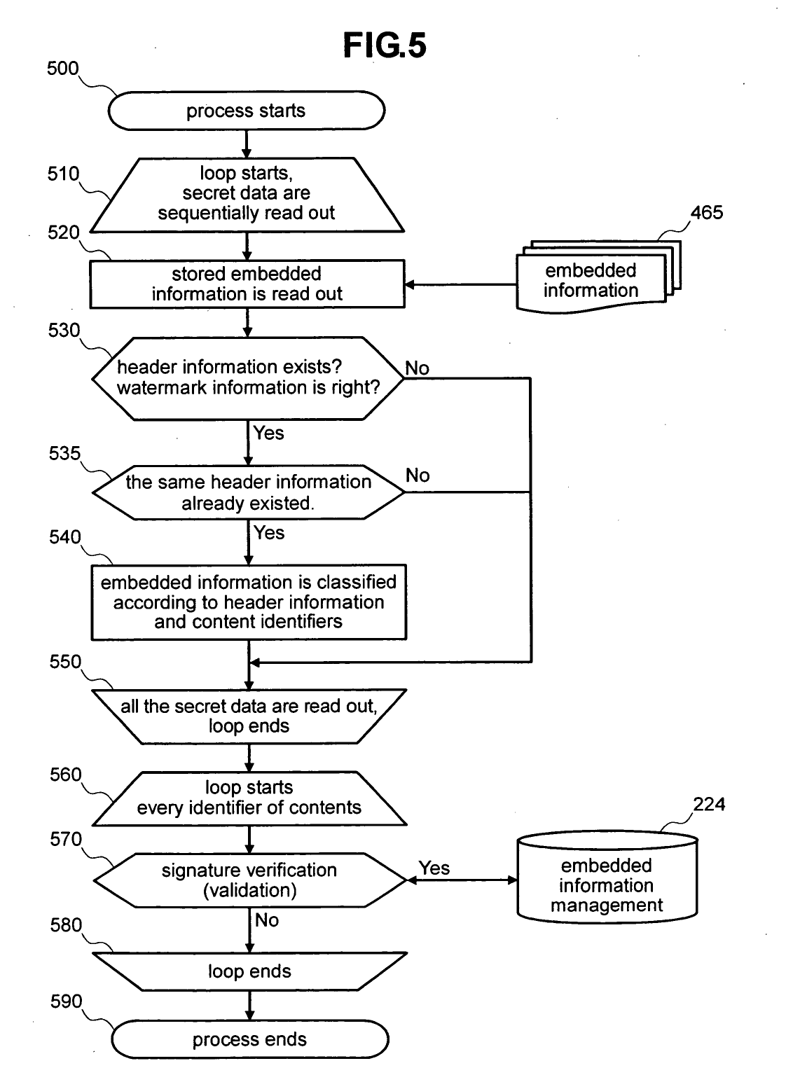

FIG. 5 is a flowchart showing a process that the verification server 120 validates the secret data recovered from the secure storage portion 136 of the user terminal 130.

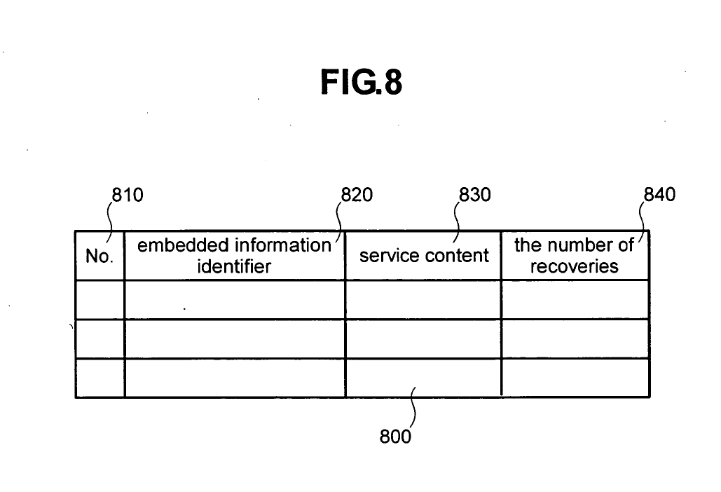

FIG. 8 is a management table of the verification server 120. A table 800 is comprised of at least a management number 810, an identifier 820 for showing a type of embedded information, a value of an electronic value (secret data) 830, and the number of recoveries 840.

A process of the verification server 120 is explained with reference to FIGS. 5 and 8.

In step 500, recovery of the secret data starts. First, the secret data divided in a loop process from step 510 to step 550 are read out and integrated. In step 520, the divided embedded information 465 are read out. In step 530, it is determined whether the header 340 is in the embedded information 465, and whether the embedded information 465 is tampered. When the embedded information 465 is tampered, a hush value of the divided data block 342 does not agree with the check code 344. When the embedded information 465 is not tampered, a hush value of the divided data block 342 agrees with the check code 344. In step 535, it is checked whether the header 340 is the same as of an already-recovered divided data.

Step 535 is a process for cases that play of a content is interrupted and that the content is played from its middle, and is a function for removing the overlapped divided data.

The embedded information extracted through the above-described filters are classified and arranged by content identifiers in step 540. By use of the header 340, which includes a unique content number and the order in one content, divided data having the same content number are rearranged according to their orders. The loop process from step 510 to step 550 is executed for all the divided data stored in the secure storage portion 136.

Next, the secret data reconstructed from the divided data through the loop process are sequentially checked in a loop process from step 560 to step 580. In other words, the public key of the content delivery server 100 is previously obtained from, e.g., the content delivery server 100, and stored in the database of the verification server 120. Instep 570, the public key is readout from the database, and the signatures are verified using the secret data and public key, and then validated. Only secret data not tampered are recorded in a table area 840 of the embedded information management database 224.

In the present embodiments, the so-called personal computers and workstations, etc. are used as the content delivery server 100, the verification server 120, and the user terminal 130. Programs operating on such computers achieve the above-described means functionally.

The user terminal in particular may be a multifunctional mobile terminal having storage means, display/input means, and communication means and being able to install programs, not limiting the so-called computer equipment.

By applying the present invention to storage type video receivers expected to become popular in the future, only persons who have viewed a complete advertisement (exactly, persons who have played the advertisement with the player) can be provided with points, electronic money, coupons, and discount tickets. Accordingly, advertising providers can understand how advertisements are viewed, and provide privileges to only frequent viewers. Additionally, it is considered that there is an effect that the frequent viewers are increased when the privileges such as the points are attractive.

When the present invention is applied to educational contents, only students who have viewed a complete content can be provided with privileges such as the points, and thus it is expected that there is an effect that their motivation for learning is increased.

According to the present invention, secret data comprised of thousands of bits can be embedded in a digital content. In other words, because the secret data can be changed to encrypted data difficult to tamper, electronic values themselves such as points and electronic money can be embedded as digital watermarks.

Additionally, because electronically-signed data can be embedded as a digital watermark, it is easily determined whether a complete digital content has been viewed only by judging whether the detected digital watermark data is complete electronically-signed data.

Further, by applying the present invention to advertisement distribution, privileges can be provided to only users who have viewed an advertisement, not when the advertisement is downloaded.

1. A data embedding method for embedding secret data in a content by use of a computer, comprising the steps of:
reading out the content and secret data from a storage device;
dividing the secret data, providing a header to a block of the divided secret data to generate partial data, and dividing the content by a number equal to or over the number of the divided secret data; and
embedding the partial data in blocks of the divided contents.

2. The data embedding method according to claim 1, further comprising the steps of:
reading out from the storage device a secret key paired with a public key stored in a user terminal in which the content is available; and
electronically signing the secret data by use of the secret key.

3. The data embedding method according to claim 2, further comprising the steps of:
generating a check code of each partial data; and
providing the check code to a block of the divided data to generate the partial data.

4. A viewing confirmation method for confirming viewing of a content having secret data embedded therein by use of a computer, comprising the steps of:
responding to a play request from a user and sequentially reading out a plurality of partial contents forming the content from a memory of the computer;
sequentially playing the partial contents
extracting, from the played partial contents, partial data of the secret data embedded in the respective partial contents by a provider of the content when play means sequentially plays the partial contents;
storing the partial data in the memory; and
inspecting whether the partial data can be integrated to reconstruct the secret data, and judging that the content has been viewed when the secret data can be reconstructed.

5. The viewing confirmation method according to claim 4, further comprising the steps of:
reading out from the memory a public key paired with a secret key generated by encrypting the secret data and verifying a signature of the secret data by use of the public key; and
judging that the content has been viewed when the signature is successfully verified.

6. A delivery server for delivering a content to a user terminal via a network, comprising:
a division portion for dividing, into a plurality of partial data, embedded data to be embedded in the content and for dividing the content into partial contents, the number of which is equal to or over that of the divided embedded data;
an embedding portion for embedding the partial data in the partial contents respectively; and
a delivery portion for delivering, to the user terminal, the contents in which the partial data are embedded.

7. The delivery server according to claim 6, wherein the division portion provides, to the partial data, identification information about the embedded data and order information about the partial data in the embedded data, respectively.

8. The delivery server according to claim 6, wherein the embedded data is valuable when all the partial data are gathered.

9. The delivery server according to claim 6, further comprising:
a storage portion for storing a secret key paired with a public key stored in the user terminal, the secret key corresponding to an identification code of the user terminal or its user;
reception portion for receiving from the user terminal a request to deliver the content;
a search portion for searching the secret key by using as a key the identification code of the user terminal or its user requesting delivery of the content; and
an encryption portion for encrypting the embedded data by use of the secret key,
wherein the division portion divides the encrypted embedded data.

10. The delivery server according to claim 9, further comprising:
a generation portion for generating a check code of the embedded data by operating a digest function or hash function upon the embedded data; and
a provision portion for providing the check code of the embedded data to the embedded data,
wherein the encryption portion encrypts the embedded data provided with the check code.

11. The delivery server according to claim 10, wherein the generation portion generates check codes of the partial data by operating the digest function or hash function upon the partial data, the provision portion provides the check codes of the partial data to the partial data, and the embedding portion embeds the partial data provided with the check codes to partial contents respectively.
